(19) United States
(12) Patent Application Publication
(10) Pub. No.: US 2010/0071915 A1
(43) Pub. Date: Mar. 25, 2010

(54) Fire sprinkler illumination system

(76) Inventor: Nelson Caldani, Richboro, PA (US)

Correspondence Address: Law Offices Zachary T. Wobensmith, III, 7746 101st Court, Vero Beach, FL, 32967-2871, US

(21) Appl. No.: 12/284,265

(22) Filed: Sep. 22, 2008

(51) Int. Cl. A62C 39/00

(52) U.S. Cl. 169/37

(57) ABSTRACT

A fire sprinkler illumination system for use with ceiling mounted fire sprinkler heads, which includes a plurality of light emitting diodes (LEDs) carried by said sprinkler heads, a source of electrical energy connected to the LEDs to provide electricity, which can be a low voltage transformer power supply connected to a source of 120 Volt AC electricity, may include an emergency battery backup electrical power supply, or be connected to a water powered electric generator turbine.

### BACKGROUND OF THE INVENTION

1. Field of the Invention

This invention relates to a fire sprinkler illumination system of the type which is used with ceiling mounted sprinklers and includes a plurality of light emitting diodes (LED's), located adjacent to and around the fire sprinkler heads to provide illumination, which LED's can be electrified by the buildings electrical system, by a battery back up power supply, or by a water powered generator, which is part of the sprinkler system.

2. Description of the Prior Art

The concept of providing a source of illumination on or adjacent to a ground sprinkler system is known in the prior art. Examples of such systems are shown in the U.S. Patent Applications Nos. US2007/0091585, U.S. 2005/0141216, and U.S. Pat. Nos. 7,182,477; 5,823,431; 5,436,811; 4,945,675; 2,883,114, and DE 4,327,199 A1. None of these systems provide illumination for ceiling mounted fire sprinkler heads.

These prior art publications and patents are mostly directed to outside or ground mounted sprinklers, and not to ceiling mounted sprinklers used in businesses and residences.

The fire sprinkler illumination system of the invention provides illumination at each sprinkler head, which can be centrally electrified by batteries, or the buildings lighting system, or by a water powered generator operated by activation of the sprinkler system.

### SUMMARY OF THE INVENTION

This invention relates to a fire sprinkler illumination system for use with ceiling mounted fire sprinkler heads, with the system including LED's adjacent to or on the sprinkler heads, which are electrified by a battery backup power supply, or the building's electrical system, or by a water powered generator actuated by operation of the sprinkler system.

The principal object of the invention is to provide a fire sprinkler illumination system on or adjacent to the sprinkler heads, which is powered by the buildings electrical system, has a battery backup power supply, or a water powered electrical generator actuated by operation of the sprinkler system.

A further object of the invention is to provide an illumination system as aforesaid, which can be used with new or existing fire sprinkler systems.

A further object of the invention is to provide an illumination system as aforesaid which has multiple sources of electrification.

A further object of the invention is to provide an illumination system as aforesaid which is safe and reliable in operation.

A further object of the invention is to provide an illumination system as aforesaid, which uses readily available components.

A further object of the invention is to provide an illumination system as aforesaid, which provides illumination at selected locations.

A further object of the invention is to provide an illumination system as aforesaid, in which a common or decorative element is used for general cabinet or task lighting, either as a primary source of light, or a secondary source.

Other objects and advantageous features of the invention will be apparent from the description and claims.

### DESCRIPTION OF THE DRAWINGS

The nature and characteristic features of the invention will be more readily understood from the following description taken in connection with the accompanying drawings forming part hereof in which:

FIG. 1 is a perspective view of a typical fire sprinkler head carrying LEDs for illumination.

FIG. 2 is a vertical sectional view illustrating a fire sprinkler head with an integrated water powered generator.

FIG. 3 is a schematic view of one embodiment of fire sprinkler illumination system with battery backup, and a low voltage remote power supply transformer actuated by a switch or sensor, and

FIG. 4 is a schematic view of another embodiment of fire sprinkler system with electrification provided by the buildings electrical system.

It should, of course, be understood that the description and drawings herein are merely illustrative, and that various modifications and changes can be made in the structures disclosed without departing from the spirit of the invention.

Like numerals refer to like parts throughout the several views.

### DESCRIPTION OF THE PREFERRED EMBODIMENTS

When referring to the preferred embodiments, certain terminology will be utilized for the sake of clarity. Use of such terminology is intended to encompass not only the described embodiment, but also technical equivalents, which operate and function in substantially the same way to bring about the same result.

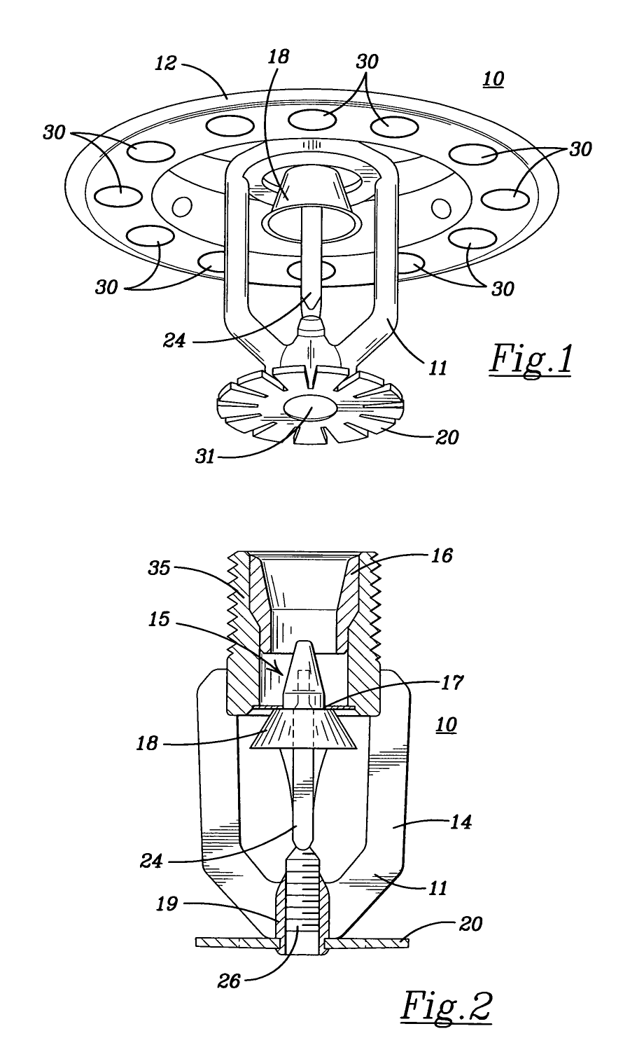

Referring now more particularly to FIGS. 1 and 2 of the drawings, a fire sprinkler head assembly 10 is therein illustrated, which assembly 10 includes a sprinkler head 11, and a trim cup 12. The sprinkler head 11 is engaged with a pipe (not shown) which is connected to a source of water under pressure (not shown).

The sprinkler head 11 is of conventional type, available from Tyco Fire and Building Products, Reliable Fire Sprinkler Systems, 103 Point View Drive, Elmsford, N.Y. 10523.

The sprinkler head 11 includes a frame 14, which has a passage way 15, with an insert 16 therein, a sealing assembly 17 in passage way 15, a button 18 in contact with sealing assembly 17, and a U shaped yoke 19 extending downwardly from frame 14, with a water deflector 20 at the bottom of yoke 19. A temperature responsive bulb 24 is provided in contact with and normally urging button 18 upwardly to prevent water exiting passageway 15, through sealing assembly 17, downwardly and contacting deflector 20.

A compression screw 26 is provided in contact with bulb 24, and engaged with yoke 19 to retain button 18 in contact with sealing assembly 17, until the bulb 24 disintegrates from a rise in temperature due to a fire.

The tri cup12 has a plurality of light-emitting diodes (LEDs) 30 therein, spaced therearound and selectively connected to a source of electrical energy (not shown) to be described. An additional LED 31 is provided carried in yoke 19 in the center of deflector 20, and is also connected (not shown) to the source of electrical energy.

Referring specifically to FIG. 2 an embodiment of the invention is illustrated with the frame 14 fitted with a water powered electrical propeller generator turbine 35 therein of well known type, available from KZL10eg, 5/F, Huolibgo Building, North High-Tech Park, Nanshen Drive, Shenzen, China

The generator 35 is connected to the LEDs 30 by wiring (not shown) and is actuated by the flow of water through passageway 15, upon the bulb 24 disintegrating, and button 18 being forced out of sealing assembly 17 by water pressure.

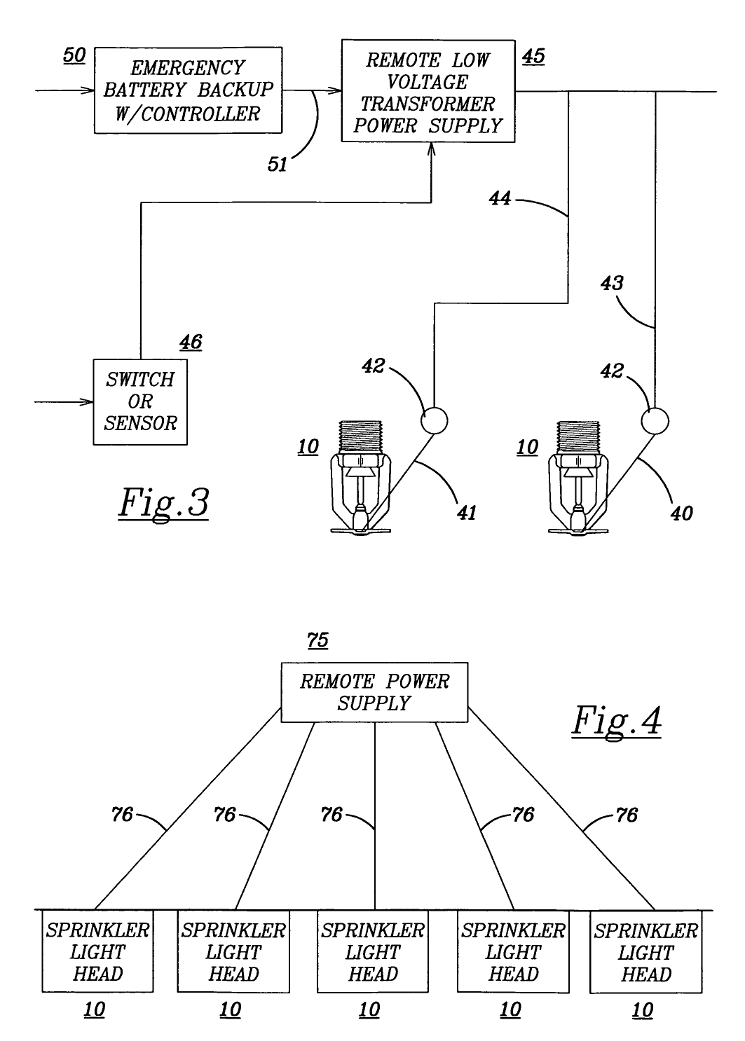

Referring now more particularly to FIG. 3 another embodiment of the invention is therein illustrated, which includes a plurality of sprinkler head assemblies 10, as described above, two being illustrated.

The sprinkler head assemblies 10 are connected by wires 40 and 41 to LED converters 42 of well known type, which are connected by wires 43 and 44 to a low voltage, 12 or 24 volt transformer power supply 45. The power supply 45 can be connected to a 120 volt AC electric source, such as the buildings electrical supply activated by a switch, or heat sensor 46, which upon demand supplies power to the transformer power supply 45, and thence to the LEDs 30.

The transformer power supply 45 has an emergency battery backup electrical source 50 connected thereto by wires 51, which source includes a battery pack (not shown), and a source of 120 Volt AC electricity connected thereto, and to a controller (not shown), which would upon demand provides 120 Volt AC to wire 51, but upon failure of the electrical source (not shown), would connect the battery pack (not shown) to provide electricity to the transformer power supply 45.

Referring more particularly to FIG. 4 another embodiment of the invention is therein illustrated which include a plurality of fire sprinkler head assemblies 10, five being illustrated, as described above. A remote electrical power supply 75 is provided, connected by wires 76 to sprinkler head assemblies 10, which supply 75 is actuated as desired to energize the LED's (not shown) carried by the assemblies 10. It will thus be seen that a fire sprinkler illumination system has been described with which the objects of the invention are attained.

I claim:

1. A fire sprinkler illumination system which comprises,
at least one ceiling mounted fire sprinkler head,
said sprinkler head having trim means engaged therewith,
a plurality of light emitting diodes (LEDs) carried by said trim means, and
a source of electrical energy connected to said LEDs for selective energization thereof.

2. A fire sprinkler illumination system as defined in claim 1 in which
said sprinkler head has at least one LED carried therein.

3. A fire sprinkler illumination system as defined in claim 1 in which
said electrical energy source is a water powered electrical generator turbine.

4. A fire sprinkler illumination system as defined in claim 1 in which
said electrical energy source includes a low voltage transformer power supply, and
a 120 Volt AC electrical power source connected to said transformer to provide electricity thereto upon demand.

5. A fire sprinkler illumination system as defined in claim 4 in which
an emergency battery backup power supply is provided connected to a controller which is connected to said transformer power supply to provide electrical power thereto upon failure of said 120 Volt AC electrical power source.
